(19) United States
(12) Patent Application Publication
(10) Pub. No.: US 2006/0140571 A1
(43) Pub. Date: Jun. 29, 2006

(54) Method and apparatus for installing an optical-fiber unit capable of removing static electricity

(76) Inventor: Bong-Hoon Lee, Gyeonggi-do (KR)

Correspondence Address: JONES DAY, 222 EAST 41ST ST, NEW YORK, NY, 10017, US

(21) Appl. No.: 10/562,487

(22) PCT Filed: Jun. 17, 2004
(86) PCT No.: PCT/KR04/01451

§ 371 Date: Dec. 23, 2005

(30) Foreign Application Priority Data
Jun. 26, 2003 (KR) 10-2003-0042174

(51) Int. Cl. G02B 6/00

(52) U.S. Cl. 385/147; 385/134

(57) ABSTRACT

Method and apparatus for installing an optical fiber unit capable of removing static electricity existing between the optical fiber unit and an installation tube, by using gas flow. In the method and apparatus, ions are included in a gas for installing the optical fiber unit so as to neutralizing and remove the static electricity generated during installation. The ions included in the installation gas may be obtained by disposing an ion generator at a front or rear end of a pressing means which compresses the installation gas.

### TECHNICAL FIELD

The present invention relates to method and apparatus for installing an optical fiber unit, and more particularly to method and apparatus for installing an optical fiber unit with the use of gas pressure.

### BACKGROUND ART

An optical fiber unit installation method using gas pressure is conducted by installing an installation tube corresponding to a micro tube or duct made of metal or polymer at a corresponding position in advance, and then applying gas with a predetermined pressure into the installation tube so that an optical fiber unit (generally called ‘Air Blown Fiber; ABF’) is inserted and installed in the tube. This method allows easy installation and removal of ABF and requires a low cost for construction, so it is widely used for installing an optical fiber unit in a narrow space like FTTH (Fiber To The Home).

In the conventional optical fiber unit installation method, an outer circumference of the optical fiber is directly contacted with an inner surface of the installation tube when the optical fiber is inserted into the installation tube. Thus, for smooth advance of the optical fiber unit, it is important to minimize a mechanical/electric friction force between the tube and the optical fiber unit.

However, though the frictional force caused by mechanical contact between the tube and the optical fiber unit may be improved to some extent by using a lubricating material to the inner surface of the tube, the electric frictional force caused by generation of static electricity is hardly eliminated, thereby giving a bad effect on the installation feature.

As a solution of the problem, there was an attempt to reduce generation of static electricity by forming a material, substantially not allowing electric charge like a glass bead, on the surface of the optical fiber unit. However, this method has several problems, namely it requires an additional process for attaching glass beads on the surface of the optical fiber unit and the glass beads are apt to be separated from the surface during the installation procedure and probably inhaled by a worker, thereby threatening the health of the worker. In addition, using the glass beads may reduce generation of static electricity, but insignificantly. Thus, the static electricity generated between the optical fiber unit and the installation tube during the installation procedure is still one of major factors deteriorating the installation features of the optical fiber unit.

### DISCLOSURE OF INVENTION

The present invention is designed to solve such problems of the prior art, and therefore an object of the invention is to provide method and apparatus for installing an optical fiber unit, which are capable of eliminating generation of static electricity between an installation tube and the optical fiber unit during the optical fiber unit installation procedure using gas pressure.

In order to accomplish the above object, the present invention provides a method for installing an optical fiber unit, which eliminates static electricity generated during the installation procedure by making ions be included in an optical fiber-unit installation gas. That is to say, the method for installing an optical fiber unit into an installation tube with the use of gas flow according to one aspect of the present invention is characterized in that the static electricity generated while the optical fiber unit is installed is eliminated by including ions into the optical fiber unit installation gas.

The ions included in the gas may be obtained by ionizing the optical fiber unit installation gas by means of an ion generating means, and the ionizing process may be accomplished before or after the gas compressing process.

In addition, a concentration of the ions included in the optical fiber unit installation gas may be controlled to be kept constantly or to be increased as time goes.

In another aspect of the invention, there is also provided an apparatus for installing an optical fiber unit, which includes an optical fiber unit supplier; a blowing head having an entrance for introducing the optical fiber unit supplied from the optical fiber unit supplier and an exit communicated with the entrance and combined with a gas-pressure installation tube; a pressing means for compressing and then supplying an optical fiber unit installation gas to the optical fiber unit introduced into the blowing head; and an ion generating means for ionizing the optical fiber unit installation gas. Here, the ion generating means may be disposed at the rear of the pressing means so as to ionize the gas compressed by the pressing means, or disposed at the front of the pressing means so as to ionize a gas to be compressed by the pressing means.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a flowchart for illustrating a method for installing an optical fiber unit according to the present invention;

FIG. 2 is a schematic view showing an apparatus for installing an optical fiber unit according to one embodiment of the present invention; and

FIG. 3 is a schematic view showing an apparatus for installing an optical fiber unit according to another embodiment of the present invention.

### BEST MODES FOR CARRYING OUT THE INVENTION

Hereinafter, preferred embodiments of the present invention will be described in detail with reference to the accompanying drawings.

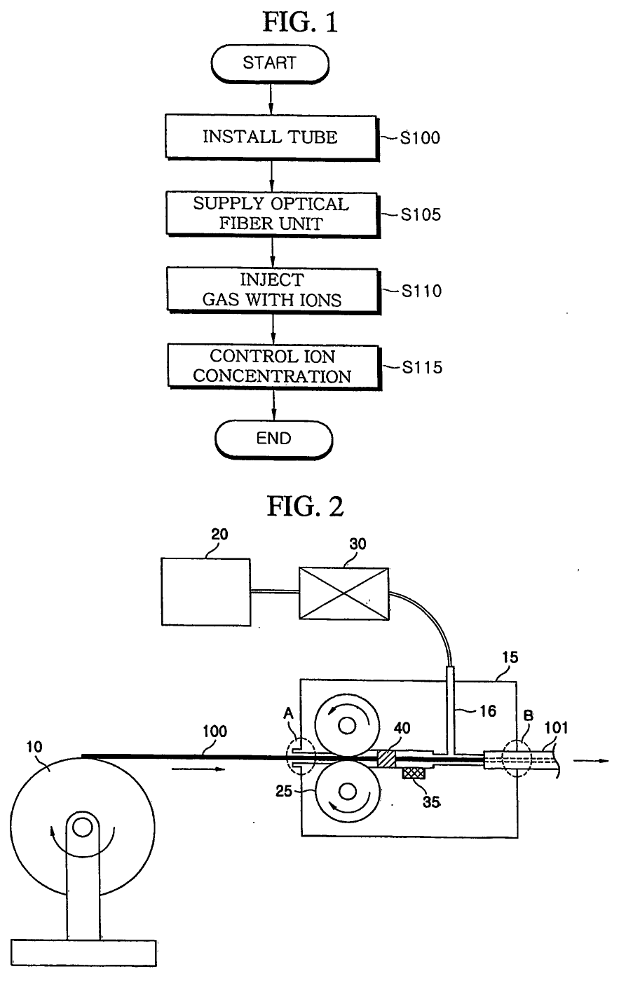

FIG. 1 is a flowchart for illustrating a method for installing an optical fiber unit according to the present invention.

Referring to FIG. 1, at first, an installation tube is installed in a predetermined section which is a target for the installation (step S100). After that, an optical fiber unit is supplied to an installation tube entrance A of a blowing head 15 (see FIG. 2) (step S105).

Subsequently, the optical fiber unit is advanced along the inside of the installation tube by injecting an installation gas with ions (step S110). The installation gas with ions not only advances the optical fiber unit with being flowed into the installation tube but also substantially eliminates static electricity by neutralizing the static electricity. Here, in order to make ions included in the installation gas, a method of ionizing a compressed gas supplied from a gas pressing means 20 (see FIG. 2) by means of an ion generating means 30 or a method of injecting ions into a compressed installation gas may be adopted. In addition to those, a method of supplying a previously ionized gas to the pressing means 20 may also be used.

Meanwhile, a frictional force caused by static electricity generated as the optical fiber unit advances into the installation tube by means of gas pressure may be changed according to various factors such as an installation distance or an installation speed of the optical fiber unit. Thus, considering such factors, ion concentration of the installation gas may be adjusted to be kept constantly or changed gradually in order to improve a static elasticity eliminating effect (step S115). In particular, since the installation distance is increased and the entire amount of the static electricity generated by friction is also increased as time goes, it is preferred that the ion concentration of the installation gas is gradually increased accordingly.

FIG. 2 shows an apparatus for installing an optical fiber unit according to one embodiment of the present invention.

Referring to FIG. 2, the optical fiber unit installing apparatus of the present invention includes an optical fiber unit supplier 10, a blowing head 15, a pressing means 20, and an ion generating means 30.

In the optical fiber unit supplier 10, a common optical fiber unit 100 for gas-pressure installation is prepared, preferably with being wound around a bobbin. The optical fiber unit 100 prepared in the optical fiber unit supplier 10 is supplied to the blowing head 15 in single or in multiple, and then introduced into a gas pressure installation tube 101.

The blowing head 15 has an entrance A for introduction of the optical fiber unit 100 and an exit B communicated with the entrance A. The common gas pressure installation tube 101 is combined to the exit B of the blowing head 15, and the pressing means 20 is connected to a conduit 16 diverged from one point between the entrance A and the exit B.

The pressing means 20 supplies a compressed installation gas with a predetermined pressure so that the optical fiber unit 100 is inserted and advanced in the gas pressure installation tube 101. At this time, a pressure of the installation gas may be set in the range of 10 to 15 atm, which may be regulated as necessary.

The ion generating means 30 is interposed between the blowing head 15 and the pressing means 20 and ionizes the compressed gas supplied from the pressing means 20. The ion generating means 30 may be selected from various well-known ion generators such as a corona-discharging ionizer for generating corona discharge by use of DC or AC high voltage to ionize surrounding gas or a light-irradiating ionizer for ionizing molecules or atoms in gas by irradiation of soft X-ray.

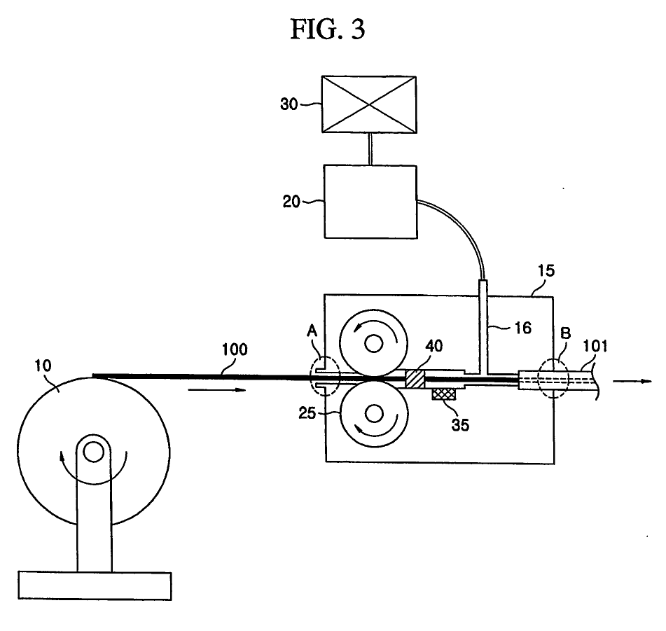

According to another embodiment of the present invention, the ion generating means 30 may be provided at the front end of the pressing means 20 so as to supply an ionized gas to the pressing means 20, as shown in FIG. 3. In this case, the gas ionized by the ion generating means 30 is transferred to the pressing means 20, and then compressed to a predetermined pressure and supplied to the blowing head 15.

Meanwhile, driving wheels 25 may be further provided in the blowing head 15 so as to control an installation speed of the optical fiber unit 100. Preferably, the driving wheels 25 have two rollers which rotate with the optical fiber unit 100 interposed therebetween, so they play a role of pushing the optical fiber unit 100 into the gas pressure installation tube 101.

In addition, the blowing head 15 may be further provided with a buckling sensor 35 installed to one side of the optical fiber unit 100 to sense an advancing state of the optical fiber unit 100. When the optical fiber unit 100 is bent due to an obstacle or the like while being advanced, the buckling sensor 35 detects displacement of the optical fiber unit 100 and then stops the installation process.

Additionally, a sealing unit 40 spaced apart from the optical fiber unit 100 at a predetermined gap to surround the outer circumference of the optical fiber unit 100 may be further provided in the blowing head 15. The sealing unit 40 prevents the compressed gas from flowing back in a direction opposite to an advancing direction of the optical fiber unit 100 and then being leaked out.

Now, operation of the optical fiber unit installation apparatus configured as above according to the present invention will be described.

The installation tube 101 which is installed in an installation section in advance is connected to the exit B of the blowing head 15, and an optical fiber unit 100 is continuously introduced into the entrance A of the blowing head 15 from the optical fiber unit supplier 10 so that the optical fiber unit 100 is supplied toward the installation tube 101.

The optical fiber unit 100 supplied toward the installation tube 101 is advanced along the inside of the installation tube 101 by means of a compressed gas injected from the pressing means 20, and then installed therein. Here, the compressed gas supplied from the pressing means 20 contains ions generated by the ion generating means 30, so it neutralizes static electricity generated during the installation process with passing through the inside of the installation tube, thereby playing a role of substantially eliminating the static electricity.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, since an ionized gas is introduced into the installation tube, static electricity existing between the inner surface of the tube and the outer circumference of the optical fiber unit may be neutralized before or during installation.

Thus, since an electric frictional force generated while the optical fiber unit is advancing in the tube is substantially eliminated, installation distance and installation speed are improved. In addition, the present invention gives an advantage of energy reduction for the optical fiber unit installation apparatus.

1-11. (canceled)

12. A method for installing an optical fiber unit with reduced static electricity, comprising the steps of:
supplying an optical fiber unit at an entrance of an installation tube; and
providing ionized gas into the tube as the optical fiber is advanced within the tube.

13. The method of claim 12 further comprising the step of ionizing the gas.

14. The method of claim 13 wherein the gas is compressed before being ionized.

15. The method of claim 13 wherein the gas is ionized before being compressed.

16. The method of claim 12 wherein the concentration of ions in the gas is controlled so as to remain constant with time.

17. The method of claim 12 wherein the concentration of ions in the gas is controlled so as to increase with time.

18. The method of claim 13 wherein the gas is ionized using a corona-discharge ionizer.

19. The method of claim 13 wherein the gas is ionized using a light-irradiating ionizer.

20. A method for installing an optical fiber unit with reduced static electricity, comprising the steps of:
supplying an optical fiber unit at an entrance of an installation tube;
injecting ions into a gas; and
providing the ion-injected gas into the tube as the optical fiber unit advances along the tube.

21. The method of claim 20 wherein the concentration of ions in the gas is controlled so as to remain constant with time.

22. The method of claim 20 wherein the concentration of ions in the gas is controlled so as to increase with time.

23. An apparatus for installing an optical fiber unit, comprising:
an optical fiber unit supplier;
a blowing head having an entrance for introducing the optical fiber unit supplied from the optical fiber unit supplier and an exit communicating with the entrance and including a gas-pressure installation tube;
a compressor for compressing and then supplying an optical fiber unit installation gas to the optical fiber unit introduced into the blowing head; and
an ionizer for ionizing the optical fiber unit installation gas.

24. The apparatus for installing an optical fiber unit according to claim 23,
wherein the ionizer is disposed at the rear of the compressor so as to ionize the gas compressed by the compressor.

25. The apparatus for installing an optical fiber unit according to claim 23,
wherein the compressor is disposed at the rear of the ionizer so as to compress the gas ionized by the ionizer.

26. The apparatus for installing an optical fiber unit according to claim 23, further comprising:
driving wheels rotating at both sides of the supplied optical fiber unit so as to push the optical fiber unit into the installation tube.

27. The apparatus for installing an optical fiber unit according to claim 23, further comprising:
a sealing unit positioned at the entrance of the blowing head to surround an outer circumference of the optical fiber unit with a predetermined gap from the optical fiber unit.

28. The apparatus of claim 23 wherein the ionizer is a corona-discharge ionizer.

29. The apparatus of claim 23 wherein the ionizer is a light-irradiating ionizer.

30. The apparatus of claim 23 further comprising a buckling sensor.

31. The apparatus of claim 23 wherein the pressure of the installation gas is in the range of 10 to 15 atm.
